(19) United States
(12) Patent Application Publication
(10) Pub. No.: US 2004/0006814 A1
(43) Pub. Date: Jan. 15, 2004

(54) Protective attachment

(76) Inventor: Perriann M. Holden, Prescott, AZ (US)

Correspondence Address: JERRY RICHARD POTTS, 3248 VIA RIBERA, ESCONDIDO, CA, 92029, US

(21) Appl. No.: 10/454,236

(22) Filed: Jun. 3, 2003

Related U.S. Application Data
(63) Continuation of application No. 09/910,641, filed on Jul. 20, 2001.
(60) Provisional application No. 60/220,357, filed on Jul. 24, 2000.

(51) Int. Cl. A62B 17/00; G21F 3/02; F41H 1/00; A41D 1/00

(52) U.S. Cl. 2/455

(57) ABSTRACT

The protective attachments (10) of the present invention provide an adhesive pad for protection and decoration that removably attaches to the bottom of the human foot, to the human hands, elbow, knees, shins, and also to animal foot pads, in a snug tight fit, and that conforms to the contour of the body part covered. The surface (12) of the protective attachment (10) worn against the body part is covered with a layer of adhesive (14) and protected by a peel sheet (18) to be removed for use. In addition, the protective attachment (10) of the present invention can be easily trimmed to provide a perfect fit to the user.

This application is a continuation-in-part of provisional application U.S. Serial No. 60/220,357 filed Jul. 24, 2000 relating to protective attachments in the form of a pad or pads which can be removably adhered to the bottoms of the feet and other parts of the body and are of a disposable nature.

### BACKGROUND OF THE INVENTION

It is sometimes desirable to provide protection from rough terrain, hot sands and pavement for the bottom of the foot without also having to wear a shoe, sandal, or otherwise having interfering ties or straps that go between the toes or over the foot. This type of foot protection is especially desirable for walking at the beach or poolside. Providing protection for the bottom of the foot without covering the top of the foot and toes may also be a fashion choice for some users, with a “barefoot” look, the user can reveal toe nail polish and toe rings. Providing for protection of the foot bottom without the confinement of a conventional shoe is also desirable in some sports such as surfing, swimming, beach volleyball, river rafting, boating, dance, aqua aerobics, and gymnastics. People with podiatric problems may also benefit from a means for providing protection for the foot without the confinement of a shoe or the straps of a sandal. Pads of animal feet may also benefit.

### SUMMARY OF THE INVENTION

The protective attachments of the present invention provide protection that removably attaches to the bottom of the foot in a snug tight fit and that conforms to the contour of the body part covered without the cumbersome weight of a conventional shoe bottom. The invention provides decorative and protective fashion wear, which may also protect several body parts including, without limitation thereto, feet, hands, elbows, knees, and parts thereof. It may be in kit form for assembly by the user and may include a pad that is easily trimmed to fit the size and shape of a body part. The pad has top and bottom surfaces, with adhesive on the top and decoration on the bottom. The adhesive is protected by a peelable film that is removed before adhering the pad to the body part selected, and the pad may be removed and optionally reaffixed with the same adhesive before discarding, although it is preferred to dispose of the attachment after a single use. The foot pads of the present invention removably adhere directly to the soles of the feet, which provides foot protection without a conventional shoe bottom. The side of the foot pad which is worn against the foot is covered with a layer of adhesive. This full-coverage of adhesive helps prevent the foot pad from becoming caught on something and pulled off the foot and also prevents dirt and debris from becoming trapped between the foot pad and the foot bottom. In addition, the foot pad of the present invention can be easily trimmed to provide a perfect fit to the foot user. The foot pad of the present invention is optionally provided with cushioning for comfort and for absorbing the shock associated with walking and sports.

### BRIEF DESCRIPTION OF THE DRAWINGS

FIG. 1 is a bottom view of the embodiment of the present invention where the foot pad is of one piece construction and covers the entire bottom of the foot.

FIG. 1A is an alternative embodiment of the foot pad shown in FIG. 1.

FIG. 2 is a side view showing the embodiment of the invention shown in FIG. 1.

FIG. 3 is a bottom view of the embodiment of the present invention where the foot pad is of two piece construction, with one piece covering the heel and a second piece covering the metatarsal region and the toes of the foot.

FIG. 3A is an alternative embodiment of the foot pad shown in FIG. 3.

FIG. 4 is a side view showing the embodiment of the invention shown in FIG. 3 and 3A.

FIG. 5 is a bottom view of the most preferred embodiment of the present invention where the foot pad is of multiple piece construction, with one piece covering the heel, a second piece covering the metatarsal region, and the remaining optional pieces covering the contact regions on the bottom of the toes.

FIG. 6 is a side view of the embodiment of the invention shown in FIG. 5.

FIG. 7 is a cross sectional view of one of the foot pads of the present invention.

FIG. 8 is a plan view of one of the toe pieces.

FIG. 9 is a bottom view of the embodiment of the present invention where the foot pad is of multiple piece construction, with one piece covering the heel and ball of the foot and the remaining optional pieces covering the contact regions on the bottom of foot and the remaining optional pieces covering the contact regions on the bottom of the toes.

FIG. 10 is a side view showing the embodiment of the invention in which the foot pad is provided with a raised arch area.

FIG. 11 is a bottom view of an embodiment of the invention in which the foot pad is secured to the foot by means of an adhesive strip surrounding the pad.

FIG. 12A is a plan view of an alternate embodiment of the invention where the pad is adhered to the palm, thumb and fingers of the hand.

FIG. 12B is a plan view of another alternate embodiment of the invention.

FIG. 12C is a plan view of another alternate embodiment of the invention.

FIG. 12D is a plan view of another alternate embodiment of the invention.

FIG. 13 is a top view of another alternative embodiment of the invention where the pad is molded to the shape and contour of the foot.

FIG. 14 is a sectional view of an alternative embodiment of the present invention wherein the bottom surface is at least partially covered with a layer of thistle cloth.

FIG. 15 is a protective shell which is shaped to fit the contour of the knee.

FIG. 16 is a protective shell which is shaped to fit the contour of the elbow.

FIG. 17 is a protective shell which is shaped to fit the contour of the shin.

FIG. 18 shows an exploded, elevation view of a presently preferred embodiment of a pad of this invention.

### DETAILED DESCRIPTION OF THE INVENTION

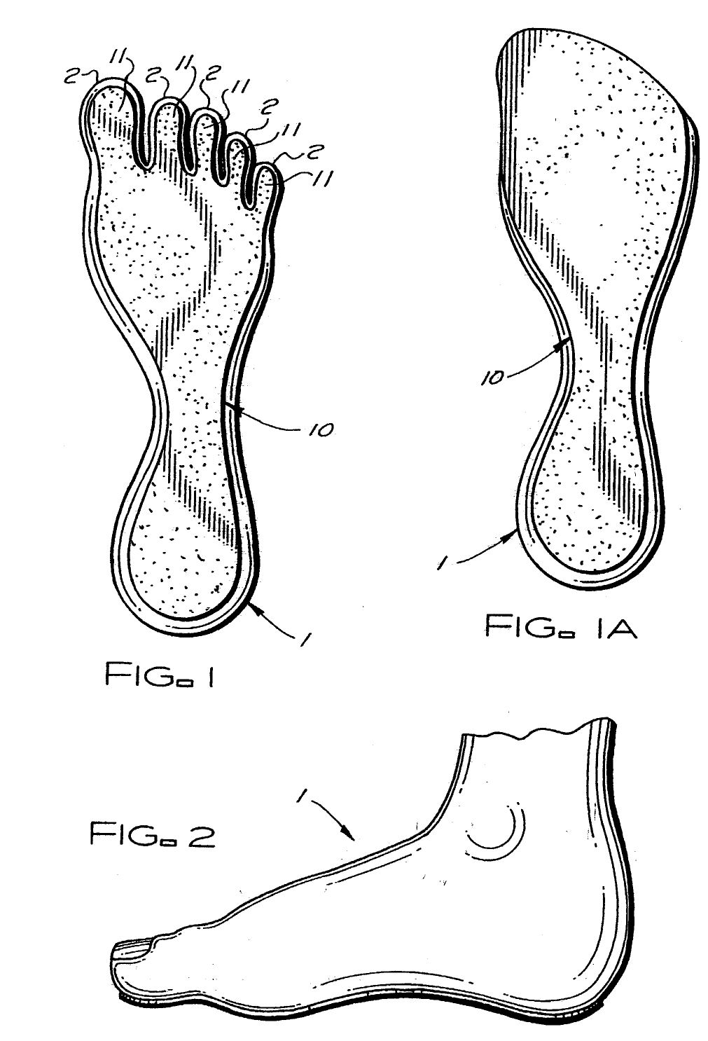

As shown in FIGS. 1 and 2, pad 10 is of single piece construction and adhesively covers the entire undersurface of foot 1. Pad 10 is relatively thin and made to conform to the shape of the foot bottom, including toes 2. Protruding portions 11 may be provided in pad 10 to cover the undersurfaces of each of toes 2. Alternatively, as shown in FIG. 1A, pad 10 may be cut to fit the general outline of the foot without protruding portions being provided for each toe.

As shown best in cross section in FIG. 7, pad 10 includes top surface 12 and bottom surface 13. As shown in FIG. 18, the several layers of a kit include the pad 10 made of ethylene vinyl acetate (EVA) (EVA-most preferred thickness is 1/16″ thick), a two sided acrylic, pressure sensitive adhesive transfer tape 17 on the top surface 12, a layer of MSX 5527 acrylate adhesive 14 (a polyurethane backing with acrylate adhesive may be obtained from 3M Healthcare as MSX 5527 acrylate polyurethane 1.2 mil thick tape), and a peel sheet 18 protecting the adhesive until ready to use. The bottom surface 13 is decorated for viewing by third parties who will see the decoration as a fashion item, e.g., sandal, glove, or knee cover. The decoration may be color, pattern, text, advertising, relief design and texture, and combinations thereof. A presently preferred mode is screen printed on EVA. Pad 10 can be made of a variety of materials including rubber, fabric, paper, plastic, synthetic materials, leather, and polyurethane foam. The material chosen for pad 10 should be of a durable yet flexible character so as to withstand wear caused by walking on the bottom surface as well as provide flexibility and comfort to the foot while walking. It is preferred that Pad 10 be provided with shock absorbing cushioning material. Pad 10 is sized to the foot by trimming away excess material with scissors. Consequently, the material chosen for pad 10 must be susceptible to easy trimming by the user. It is also preferable that the material chosen for pad 10 be inexpensive so that pad 10 may be removed and optionally discarded after each use.

Pad 10 can be made of all one material, or a different material may be used in middle layer 15. If desired, cushioning or gel may be used in middle layer 15. Alternatively, a magnetic material may be used in middle layer 15. In one embodiment of the invention, inserts are positioned in pad 10 so as to apply pressure at desired pressure points on the bottoms of the feet. In the embodiment of the invention shown in FIG. 10, pad 10 is optionally provided with raised arch area 16. Raised arch area 16 provides for additional support of the foot as well as excellent adhesion of pad 10 to the foot.

Bottom surface 13 is intended for contacting the ground during use. It is preferred that bottom surface 13 is waterproof or water resistant and is further provided with a non-slip texture. If desired, bottom surface 13 can be decorated with color, patterns, messages, trademarks, or advertisements.

In an alternate embodiment of the invention, bottom surface 13 is at least partially covered with a layer of thistle cloth. The layer of thistle cloth on bottom surface 13 may then be removably adhered to a complimentary layer of thistle cloth on a ground contacting base which then protects the foot from direct contact with the ground.

As further shown in FIG. 7, pad 10 also includes top surface 12 which is covered with a layer of adhesive. The adhesive selected should be of sufficient strength to hold pad 10 onto the bottom of foot 1 during normal walking and running use of pad 10. However, the adhesive must not be so strong as to prevent removal of pad 10 by the user when the user has finished wearing the pad. Alternatively, an adhesive which requires a special solution for breaking down the adhesive and removing the pad may be used. It is desirable that the adhesive selected be waterproof as well as compatible with skin on the bottom of the foot. In an alternate embodiment of the invention, it is desirable that the adhesive selected enable the user to remove and then reapply the pad about two (2) times and at least one (1) time.

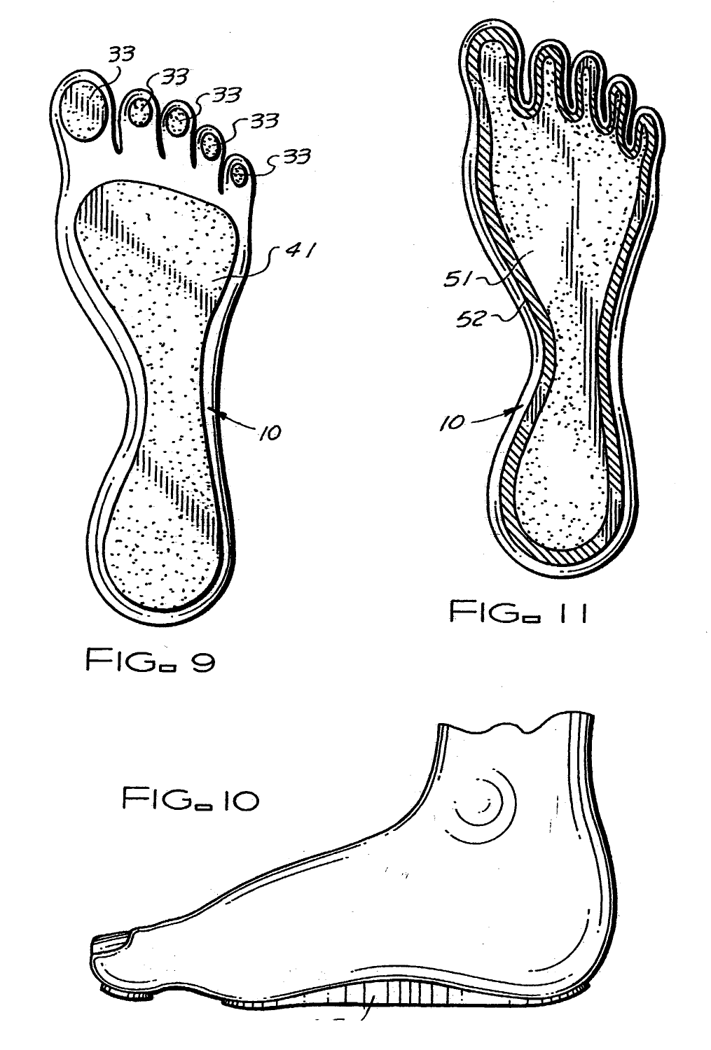

In an alternate embodiment of the invention shown in FIG. 11, pad 10 has inner cushioned area 51 with an outer adhesive strip 52, which surrounds area 51. Because adhesive strip 52 completely surrounds area 51, dirt and debris cannot become trapped between cushioned area 51 and the foot.

As shown in FIG. 7, pad 10 may optionally include peel sheet 14, which protects the adhesive on top layer 12 until pad 10 is to be applied to the foot. Immediately prior to applying pad 10 to the foot, the user removes peel sheet 14 to reveal the adhesive surface.

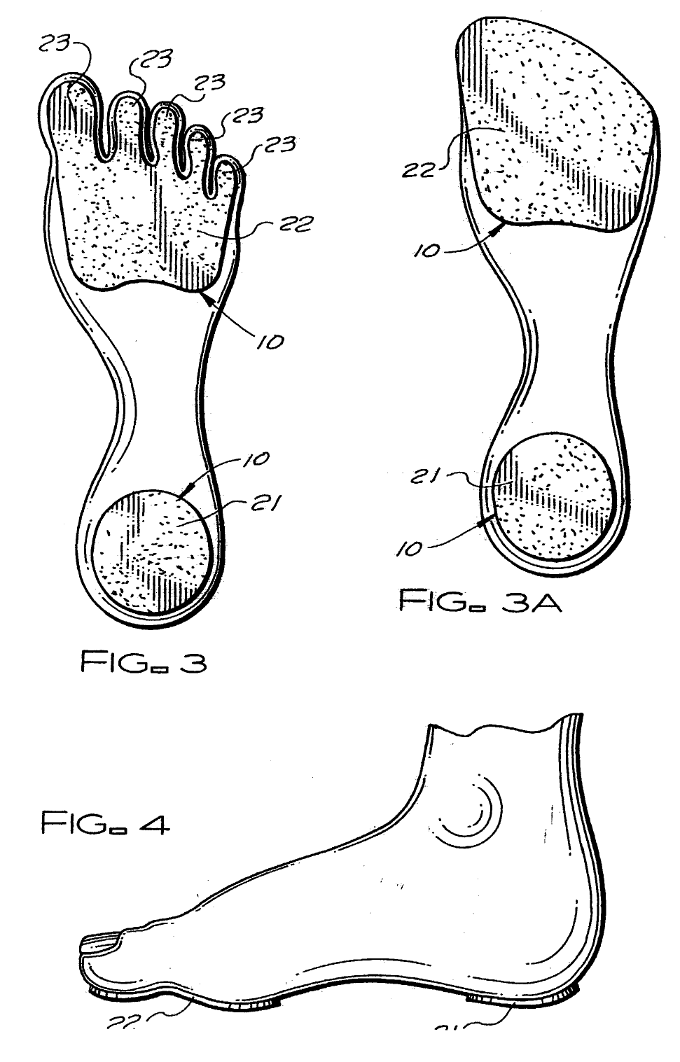

In an alternate embodiment of the invention shown in FIGS. 3 and 4, pad 10 is divided into a first heel piece 21 and a second piece 22 covering the metatarsal region and toes of the foot. Protrusions 23 may be cut to cover the underside of each toe. Alternatively, as shown in FIG. 3A, piece 22 may be cut to fit the general outline of the metatarsal region without protruding portions being provided for each toe.

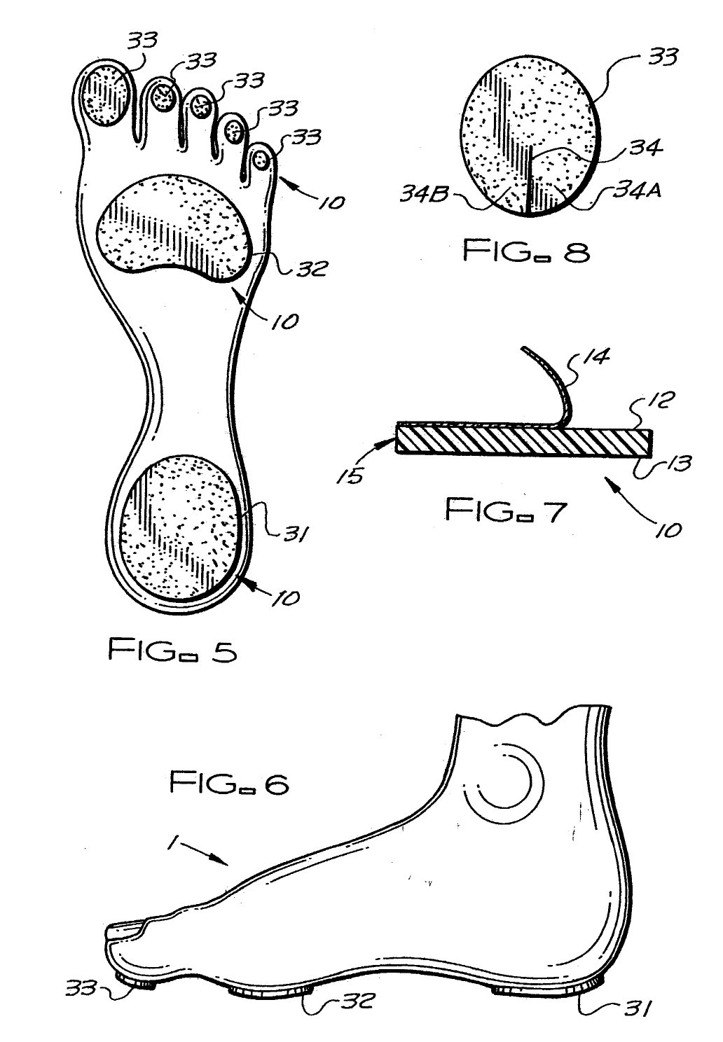

In the embodiment of the invention which is presently preferred, and which is shown in FIGS. 5 and 6, pad 10 is divided into a first heel piece 31, a second metatarsal piece 32 covering the metatarsal region without toes as the most preferred embodiment and optionally as a lesser preferred embodiment, toe pieces 33 covering the ground contact regions on the bottoms of the toes. In still another embodiment of the invention, shown in FIG. 9, pad 10 is divided into one piece 41 covering the heel and metatarsal regions of the foot and optional toe pieces 33 covering the ground contact regions on the bottoms of the toes. The embodiments of the invention shown in FIGS. 5, 6, 9, and 10 may be worn with or without toe pieces 33, toe-less being the presently most preferred embodiments.

As shown best in FIG. 8 each of toe pieces 33 may optionally be provided with slit 34. Flaps 34A and 34B are located on either side of slit 34. Once peel sheet 14 has been removed, but before toe piece 33 is mounted on the foot, flap 34A may be folded over flap 34B to create a cup shaped toe piece. Applicant has discovered that providing toe pieces 33 with an inner cushioned area surrounded by an outer adhesive strip, as shown in one embodiment in FIG. 11, is an especially good means for removably adhering toe pieces 33 to the ground contact regions on the bottoms of the toes.

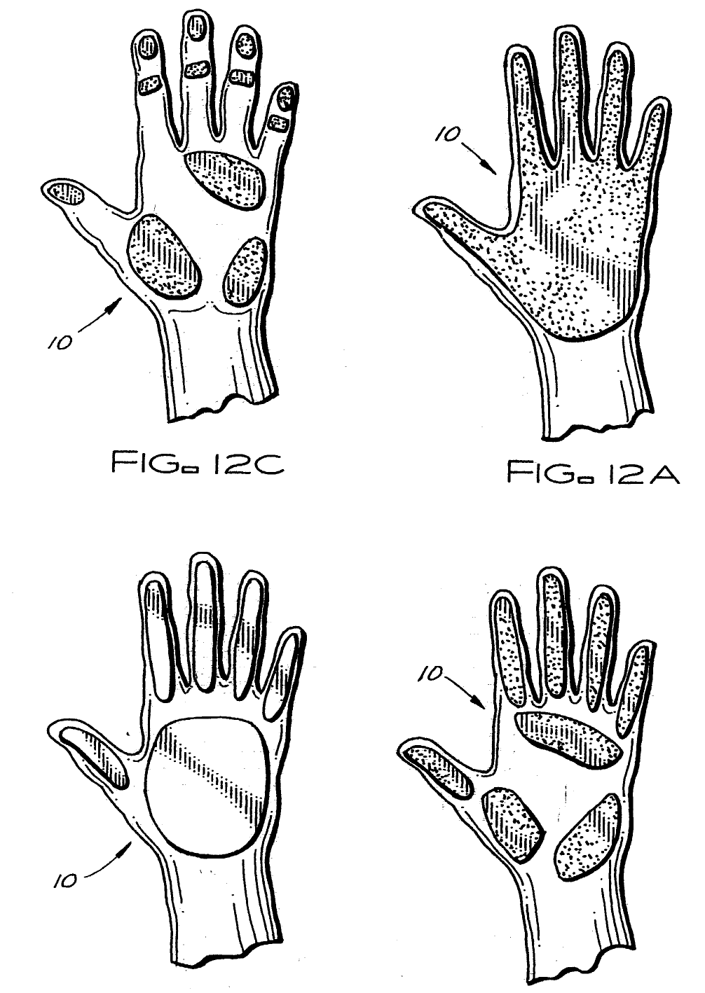

In another alternate embodiment of the invention, shown in FIGS. 12A through 12D, pad 10 is removably adhered to the palm, thumb and fingers of the hand as a means of protecting the hand or as a means of personal ornamentation. When used as a means of hand protection, pad 10 may be used in place of gloves in such activities as golf, tennis, racquetball, baseball, weight lifting, rock climbing, bike riding, motorcycle riding, gardening, and certain occupations. When used on the hand, pad 10 may be of single piece construction as shown in FIG. 12A, or multiple piece construction with one piece covering the palm and another 5 pieces covering the underside of the thumb and fingers as shown in FIG. 12D. Alternatively, as shown in FIGS. 12B and 12C, separate pads may be applied to the contact regions on the bottoms of the hands. One piece covering just the palm of the hand may be also worn. Alternatively, for applications such as rock climbing, it may be desirable to just wear pieces covering the fingers and thumb. Depending upon the application, pad 10 may optionally be provided with cushioning means or a non-slip, gripping texture.

While gloves can provide hand protection, they are confining and often cause the user's hands to sweat within the gloves. Additionally, long fingernails and rings may make wearing gloves difficult for some individuals. Use of pad 10 instead of gloves provides for hand protection, better air circulation to the hand, as well as the ability to wear and display long fingernails and rings. Unlike some gloves, pad 10 can be disposable, and the protective attachments of the present invention may be removed and discarded after each use. This allows the user to apply new, clean pads 10 at each use. When used on the hand, pad 10 can also be decorated with color, patterns, messages, trademarks, or advertisements.

In an alternate embodiment of the invention, when pad 10 is made to adhere to the hand, pad 10 may be provided with a layer of thistle cloth. The layer of thistle cloth on pad 10 may then be removably adhered to a complimentary layer of thistle cloth on a surface contacting base, which then protects the hand from direct contact with the surface.

In another alternative embodiment of the invention, pad 10 is shaped and sized to be applied to the feet of children and pets.

In another alternative embodiment of the invention, shown in FIG. 13, pad 10 is molded to the shape and contour of the foot. In this embodiment, pad 10 can be provided with a raised arch area and a slight ridge at the heel. The toe area of pad 10 is left available for trimming to size.

In yet another alternative embodiment of the invention, pad 10 is removably adhered to the elbows, knees, and/or shins to provide protection during activities such as roller blading, skate boarding, bike riding, soccer, and motorcycle riding. Pad 10 may be applied to the knees to provide protection to skin or garments during gardening.

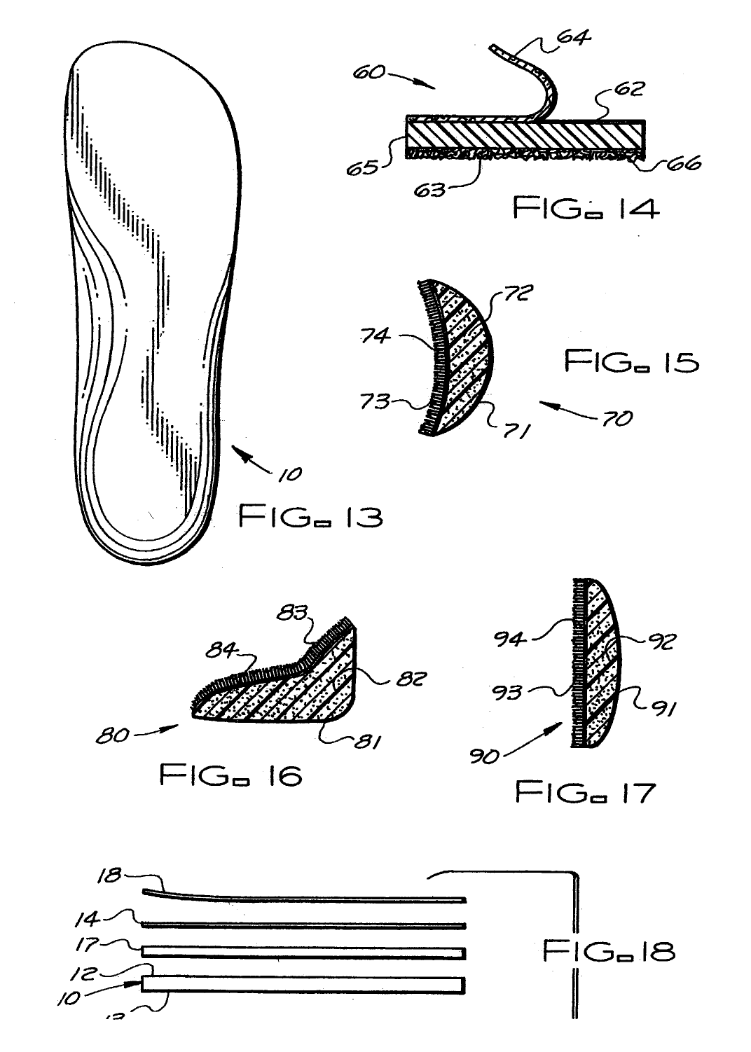

Yet another alternative embodiment of the invention is shown in FIGS. 14, 15, 16 and 17. This embodiment of the invention includes pad 60 and one of the protective shells shown in FIGS. 15, 16 or 17. In some sports, such as roller blading or skate boarding, it is desirable to have additional padding for protection against injury. The protective shells shown in FIGS. 15 through 17 provide additional padding for protection against injury. However, because the cost of manufacturing the protective shells may be higher than the cost of manufacturing pad 60, it is desirable that pad 60 be disposable after one or two uses, while the protective shells may be used many times.

As shown in FIG. 14, pad 60 includes top surface 62, middle layer 65, and bottom surface 63. As with pad 10, pad 60 can be made of a variety of materials including rubber, fabric, paper, plastic, synthetic materials, leather, and polyurethane foam. Top surface 62 is covered by a layer of adhesive. The adhesive selected should be of sufficient strength to adhere pad 60 to the elbows, knees, or shins. However, the adhesive must not be so strong as to prevent removal of pad 60 by the user when the user has finished wearing the pad. Pad 60 is optionally provided with a peel sheet 64, which protects the adhesive on top surface 62 until pad 60 is applied. Immediately prior to applying pad 60, the user removes peel sheet 64 to reveal the adhesive surface. Bottom surface 63 of pad 60 is at least partially covered with a layer of thistle cloth 66.

Protective shells 70, 80 and 90 are respectively shown in FIGS. 15, 16 and 17. As shown in FIG. 15, protective shell 70 comprises durable outer surface 71 which is shaped to fit the contour of the human knee. Protective shell 70 further includes a middle layer of impact absorbing padding 72 and inner surface 74, which is also shaped to fit the contour of the knee. Thistle cloth 73 at least partially covers inner surface 74 and engages complimentary thistle cloth 66 on bottom surface 63 of pad 60.

Similarly, as shown in FIG. 16, protective shell 80 comprises durable outer surface 81 which is shaped to fit the contour of the human elbow. Protective shell 80 further includes a middle layer of impact absorbing padding 82 and inner surface 84, which is also shaped to fit the contour of the elbow. Thistle cloth 83 at least partially covers inner surface 84 and engages complimentary thistle cloth 66 on bottom surface 63 of pad 60.

As with protective shells 70 and 80, protective shell 90, shown in FIG. 17, comprises durable outer surface 91 which is shaped to fit the contour of the human shin. Protective shell 90 further includes a middle layer of impact absorbing padding 92 and inner surface 94, which is also shaped to fit the contour of the shin. Thistle cloth 93 at least partially covers inner surface 94 and engages complimentary thistle cloth 66 on bottom surface 63 of pad 60.

Protective shells 70, 80, and 90 can be made in a variety of sizes to fit differently sized adults and children.

A variety of adhesives are available for adhering pads 10 and pads 60 to the body. Of the available adhesives; the adhesive used by Johnson & Johnson in its hydrocolloid adhesive Band-Aid® Callus Relief product featuring Compeed® Moisture Seal™ Technology and as disclosed in U.S. Pat. No. 4,367,732; U.S. Pat. Nos. 4,867,748; and 5,643,187 is among the adhesives presently preferred. The adhesive used in Dr. Scholl's® Waterproof Corn Cushions is more preferred, especially for applying toe pieces 33 to the ground contact regions on the bottoms of the toes. MSX 5527 PU tape—acrylate adhesive with polyurethane backing by 3M is most preferred, especially for applying toe pieces 33 to the ground contact regions on the bottoms of the toes.

What is claimed:

1. A novelty kit for providing decorative and disposable fashion wear for body parts that also protects the decorated body parts from abrasion, comprising:
a) a flexible, trimmable pad having top and bottom surfaces;
b) an adhesive material on said top surface for removably securing said pad to a body part;
c) a decoration to be applied to said bottom surface; and
d) a removable layer covering said adhesive material.

2. A method of decorating and protecting a body part comprising the steps of:
a) furnishing a flexible pad having a top and bottom surface;
b) providing an adhesive on said top surface and a peelable film to preserve said adhesive until used;
c) providing decoration selected from at least one of the group comprising color, pattern, graphic design, text, advertising, relief design, and texture;
d) trimming said pad to a desired shape to apply to at least one body part selected from the group comprising feet, hands, knees, and elbows, and parts thereof;
e) peeling said film from said adhesive and applying said pad to a selected body part.

3. The invention of claim 1 further comprising a reusable adhesive.

4. The invention of claim 1 further comprising preformed, cupped pads for at least one of toes, knees, elbows, and animal pads.

5. The invention of claim 1 further comprising material selected from cushioning, magnetic material, and gel disposed in said pad between said top and bottom surfaces.

6. The invention of claim 1 further comprising the addition of a first layer of thistle cloth to at least a portion of said bottom layer and a protective shell having a second layer of thistle cloth to engage said first layer of thistle cloth and means for absorbing the shock of a blow to said shell.

7. The invention of claim 1 further comprising means for adapting said pad to apply to the feet of animal pets.

8. The invention of claim 2 further comprising a reusable adhesive.

9. The invention of claim 2 further comprising pre-formed, cupped pads for at least one of toes, knees, elbows and animal pads.

10. The invention of claim 2 further comprising material selected from cushioning, magnetic material, and gel disposed in said pad between said top and bottom surfaces.

11. The invention of claim 2 further comprising the addition of a first layer of thistle cloth to at least a portion of said bottom layer and a protective shell having a second layer of thistle cloth to engage said first layer of thistle cloth and means for absorbing the shock of a blow to said shell.

12. The invention of claim 2 further comprising means for adapting said pad to apply to the feet of animal pets.
